(19) United States
(12) Patent Application Publication
(10) Pub. No.: US 2012/0251188 A1
(43) Pub. Date: Oct. 4, 2012

(54) DEVELOPER, IMAGE FORMATION UNIT, AND IMAGE FORMATION APPARATUS

(75) Inventor: Yuki MATSUURA, Tokyo (JP)

(73) Assignee: OKI DATA CORPORATION, Tokyo (JP)

(21) Appl. No.: 13/425,532

(22) Filed: Mar. 21, 2012

(30) Foreign Application Priority Data
Apr. 4, 2011 (JP) 2011-082741

(51) Int. Cl. G03G 15/08; G03G 9/087

(52) U.S. Cl. 399/265; 430/109.1

(57) ABSTRACT

A developer includes particles of developer base material containing a binder resin and external additive added to surfaces of the particles of developer base material. A loose bulk density is not smaller than 0.300 g/ml but not larger than 0.420 g/ml, and a release rate of the external additive from the particles of developer base material is not lower than 5% but not higher than 15%.

### CROSS REFERENCE TO RELATED APPLICATIONS

This application claims priority based on 35 USC 119 from prior Japanese Patent Application No. 2011-082741 filed on Apr. 4, 2011, entitled “DEVELOPER, IMAGE FORMATION UNIT, AND IMAGE FORMATION APPARATUS”, the entire contents of which are incorporated herein by reference.

### BACKGROUND OF THE INVENTION

1. Field of the Invention

The present disclosure relates to a developer, an image formation unit, and an image formation apparatus.

2. Description of Related Art

An electrophotographic image formation process generally includes a charge process, an exposure process, a development process, a transfer process, and a fixture process. In the charge process, an image carrier including a photoconductive insulator layer is electrically charged uniformly. In the exposure process, the electrically-charged photoconductive insulator layer is exposed to light, and thereby the electric charges situated in the exposed portions are extinguished to form a latent image. In the development process, the latent image thus formed is visualized by adhering toner, which is a developer containing at least resin and colorant, to the latent image by means of a developer roller. In the transfer process, the visible image thus obtained is transferred onto a print medium such as transfer paper. In the fixture process, the visible image thus transferred to the print medium is fixed by heating and pressuring, or by other appropriate fixture methods.

The developer used by image formation apparatuses that forms images by the electrophotographic method is commonly fabricated by adhering external additives to the particles of toner base material. The toner base material contains a pigment, resin, wax, a charge-control agent, and the like, and has an adjusted molecular weight.

For example, Japanese Patent Application Publication No. 2004-341122 discloses a developer with a saturation apparent density of not more than 0.427 g/ml. The disclosed developer is designed to achieve favorable image quality without causing contamination in an image even when low-duty printing is performed in a low temperature and low humidity environment.

### SUMMARY OF THE INVENTION

The use of the developer disclosed in the above-mentioned document tends to delay the first print.

An object of an embodiment of the invention is to speed up the first print time.

An aspect of the invention is a developer including: particles of developer base material containing a binder resin; and external additive added to surfaces of the particles of developer base material. A loose bulk density is not smaller than 0.300 g/ml but not larger than 0.420 g/ml, and a release rate of the external additive from the particles of developer base material is not lower than 5% but not higher than 15%.

According to the aspect, it is possible to speed up the first print time.

### BRIEF DESCRIPTION OF THE DRAWINGS

FIG. 1 is a diagram illustrating the general configuration of a printer.

FIG. 2 is a diagram illustrating the general configuration of an image formation unit.

FIG. 3 is a graph summarizing assessment results of various toners according to a first embodiment.

FIG. 4 is a graph summarizing assessment results of various toners according to a second embodiment.

### DETAILED DESCRIPTION OF EMBODIMENTS

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

### First Embodiment

Firstly, a description is given of a printer which is an image formation apparatus configured to form an image by using a toner serving as a developer of the invention. Then, a description is given of an image formation unit configured to visualize a latent image on a latent image carrier by supplying a toner to the latent image. Finally, a description is given of the toner.

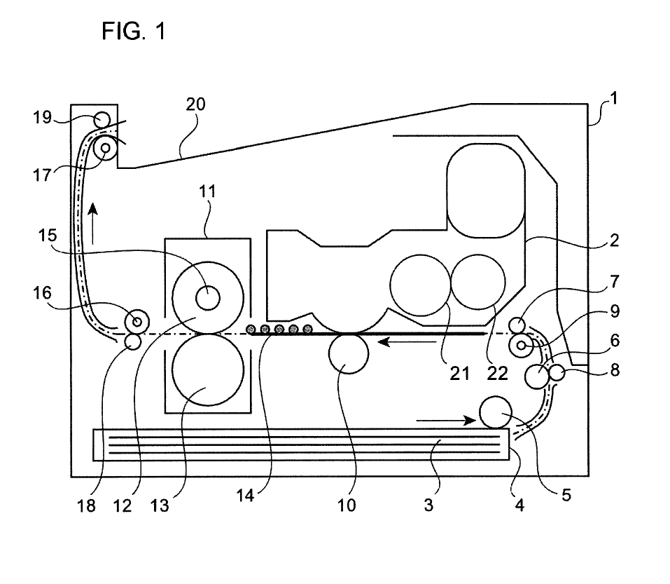

As shown in FIG. 1, printer 1 is an image formation apparatus configured to form an image on a print medium by the electrophotographic method. Printer 1 with the above-mentioned function includes image formation unit 2 configured to form a black toner image, and includes fixture unit 11. Image formation unit 2 and fixture unit 11 are provided along a substantially S-shaped sheet conveyance path starting from sheet cassette 4 and ending at paired sheet discharge roller 17 and pinch roller 19. In addition, printer 1 includes a conveyance roller and the like configured to convey paper sheet 3 as a print medium to image formation unit 2 and to fixture unit 11.

Sheet cassette 4 stores paper sheets 3 therein while stacking paper sheets 3. Sheet cassette 4 is detachably attached to a lower portion of printer 1. Hopping roller 5 is provided above an upper portion of sheet cassette 4, and configured to pick up paper sheets 3 stored in sheet cassette 4 on a one-by-one basis from the uppermost portion and to send picked-up paper sheet 3 in the direction indicated by an arrow in FIG. 1.

Conveyance roller 8 is used as a pair with pinch roller 6 to hold and convey paper sheet 3 sent by Hopping roller 5. Register roller 9 is used as a pair with pinch roller 7 to correct the orientation of paper sheet 3 conveyed from paired conveyance roller 8 and pinch roller 6 when paper sheet 3 is conveyed obliquely. Register roller 9 and pinch roller 7 then convey paper sheet 3 to image formation unit 2. Some of the rollers mentioned above are driven to rotate by the power transmitted from corresponding drive motors (not illustrated) via gears or the like.

Image formation unit 2 is detachably attached to printer 1 at a position along the sheet conveyance path. In image formation unit 2, a latent image is formed on photosensitive drum 24 serving as an image carrier by the light cast from LED (light emitting diode) head 25, which is described later. The latent image is visualized by adhering toner 14 onto the photosensitive drum and thus a toner image is formed. More details about image formation unit 2 are provided later.

Transfer roller 10, which is made of a conductive rubber or the like, is provided to be pressed against photosensitive drum 24. When a bias voltage is applied to transfer roller 10 by an unillustrated power source for transfer roller, transfer roller 10 transfers the toner image formed on photosensitive drum 24 to paper sheet 3.

Fixture unit 11 serving as a fixture unit is provided on the sheet conveyance path on the downstream side of image formation unit 2, and includes heat roller 12, backup roller 13, and an unillustrated thermistor. Heat roller 12 is formed, for example, by coating a cylindrical hollow metal core made of aluminum or the like with a heat-resistant elastic layer made of a silicone rubber, and then by coating the heat-resistant elastic layer with a PFA (tetra fluoro ethylene-perfluoro alkylvinyl ether copolymer) tube. Halogen lamp 15 is provided in the metal core. Backup roller 13 is formed, for example, by coating a metal core made of aluminum or the like with a heat-resistant elastic layer made of a silicone rubber, and then by coating the heat-resistant elastic layer with a PFA tube. A pressure-contact unit is formed between heat roller 12 and backup roller 13. The thermistor capable of detecting the surface temperature of heat roller 12 is provided near heat roller 12 in such a manner that the thermistor and the heat roller are not in contact with each other. Halogen lamp 15 is controlled based on the detection result of the surface temperature of heat roller 12 detected by the thermistor so that the surface temperature of heat roller 12 can be kept at a predetermined temperature. Paper sheet 3 with the transferred visible image passes through the pressure-contact unit formed of backup roller 13 and heat roller 12 whose temperature is kept at a predetermined temperature. Accordingly, heat and pressure are applied to paper sheet 3, then toner 14 on paper sheet 3 is melted and thereby the toner image is fixed to paper sheet 3.

Sheet discharge roller 16 is used as a pair with pinch roller 18 to hold and convey paper sheet 3 passing through fixture unit 11. Sheet discharge roller 17 is used as a pair with pinch roller 19 to discharge, to sheet stacker 20, paper sheet 3 conveyed from paired sheet discharge roller 16 and pinch roller 18. Sheet stacker 20, which is formed by using an external surface of the chassis of printer 1, stacks paper sheets 3 discharged by paired sheet discharge roller 17 and pinch roller 19.

Although not illustrated in FIG. 1, printer 1 includes other members such as a print controller, an interface controller, a reception memory, an image-data-editor memory, a display unit, an operation unit, various kinds of sensors, a head-drive controller, a temperature controller, a sheet-conveyance-motor controller, a roller-drive-motor controller, and a high-voltage power source. The print controller includes a microprocessor, a ROM (read only memory), a RAM (random access memory), an input-output port, a timer, and the like. The interface controller receives print data and control commands, and thereby controls the overall operational sequence of printer 1 to execute printing. The reception memory temporarily stores the print data received through the interface controller. The image-data-editor memory receives the print data stored in the reception memory, and stores image data created by editing the print data. The display unit includes a display device, such as an LCD (liquid crystal display), configured to display the state of printer 1. The operation unit includes an input device, such as a touch panel, configured to receive instructions from a user. The sensors are configured to monitor the operation state of printer 1. Examples of the sensors include a sheet-position detection sensor, a temperature-humidity sensor, and a print-density sensor. The head-drive controller sends, to LED head 25, the image data stored in the image-data-editor memory, and controls the drive of LED head 25. The temperature controller controls the temperature of fixture unit 11. The sheet-conveyance-motor controller controls drive motors configured to rotate various rollers to convey paper sheets 3. The roller-drive-motor controller controls drive motors configured to rotate various rollers such as photosensitive drum 24. The high-voltage power source applies voltages to the rollers.

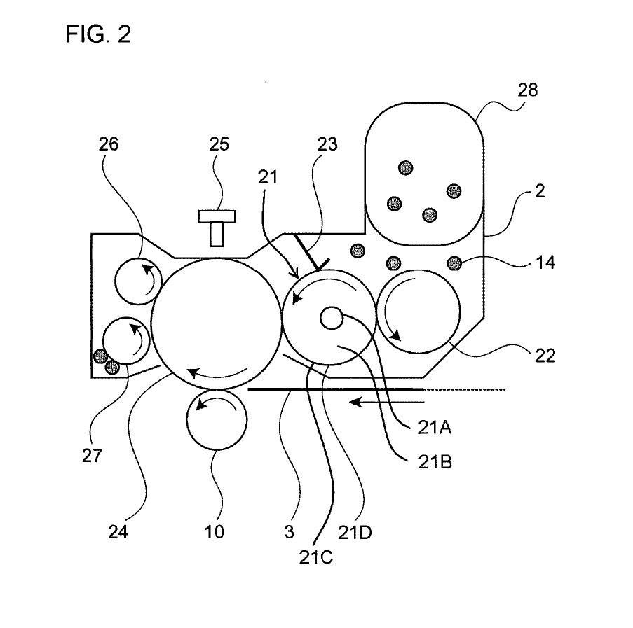

Next, the configuration of image formation unit 2 is described with reference to FIG. 2. FIG. 2 is a diagram illustrating the general configuration of image formation unit 2.

Image formation unit 2 includes developer roller 21 serving as a developer carrier, sponge roller 22 serving as a developer supplier, development blade 23 serving as a toner-layer regulator, photosensitive drum 24 serving as a latent-image carrier, LED head 25 configured to form a latent image on the surface of photosensitive drum 24, charger roller configured to electrically charge the surface of photosensitive drum 24, and cleaner roller 27 configured to scrape off toner 14 that remains on the surface of photosensitive drum 24 without being transferred onto paper sheet 3.

Developer roller 21 includes conductor shaft 21A, elastic layer 21B, surface-coating layer 21C, and silane coupling-agent layer 21D. Elastic layer 21B, which is formed on conductor shaft 21A, is made of a semiconductor silicone rubber treated with UV rays. Surface-coating layer 21C, which is made of a urethane-based resin, is formed by applying a coating to the surface of elastic layer 21B. Silane coupling-agent layer 21D is formed by a surface treatment (e.g., an aminosilane treatment) of surface-coating layer 21C. Silane coupling-agent layer 21D and surface-coating layer 21C together form a coat layer. The coat layer (21C, 21D) contains silica particles that give roughness to the surface. The coat layer (21C, 21D) has a thickness of 7 μm to 13 μm. The surface of the coat layer (21C, 21D) is polished so that the surface roughness of the coat layer (21C, 21D) can be Rz=3 μm to 12 μm (JIS B0601-1994). Note that for the purpose of securing a print density, a larger value of Rz is more preferable. The developer-roller resistance is measured by bringing a ball bearing (which is made of a SUS material and has a width of 2.0 mm and a diameter of 6.0 mm) into contact with the roller with a force of 20 gf and applying a DC voltage of 100 V between the bearing and the shaft. On the basis of the formula R (resistance)=V (voltage)/I (current), the developer-roller resistance shows values of 100 MΩ to 5000 MΩ. Developer roller 21 used in the first embodiment has an external diameter of 17.52 mm, and rotates at a speed of 206.26 rpm.

Sponge roller 22 includes a conductor shaft coated with a semiconductor foamed silicone rubber. The surface of sponge roller 22 is polished so that sponge roller 22 can have a predetermined external diameter. The silicone rubber is a raw rubber, such as dimethyl silicone raw rubber and methyl phenyl silicone raw rubber, provided with a reinforcement silica filler, a vulcanization agent required for vulcanization and hardening, and a foaming agent. Examples of foaming agents that can be used herein include foaming agents such as sodium bicarbonate, and organic foaming agents, such as azodicarbonamide (ADCA). Sponge roller 22 used in the first embodiment has an external diameter of 14.60 mm, and rotates at a speed of 138.44 rpm. The sponge-roller hardness is measured with Asker Durometer Type F (manufactured by Kobunshi Keiki Co., Ltd.), and is 48±5 degrees. The sponge-roller resistance is measured in the same manner as the case where the developer-roller resistance is measured. The sponge-roller resistance, however, is measured with application of a 300-V DC voltage. The measurement result shows resistance values of 1 MΩ to 100 MΩ. In image formation unit 2, sponge roller 22 is pressed into the surface of developer roller 21 to a depth of 1.0±0.15 mm.

Development blade 23 is made of an SUS material with spring characteristics, and has a thickness of approximately 0.1 mm. The leading end portion of a first end of development blade 23 is folded outwards into an L-shape. The leading end portion of the first end of development blade 23 is brought into contact with developer roller 21 with a predetermined contact force during the image-formation operation, which is described later.

Photosensitive drum 24 serving as a latent-image carrier includes a conductive support member and photoconductive layers. Photosensitive drum 24 is an organic photosensitive member fabricated by sequentially forming an electric-charge generation layer and an electric-charge conveyance layer serving as the photoconductive layers on a metal (aluminum) pipe that is used as the conductive support member. Photosensitive drum 24 used in the first embodiment has an external diameter of 30 mm and rotates at a speed of 103.13 rpm.

LED head 25 includes, for example, an LED element and a lens array. LED head 25 is provided at a position that allows the light emitted from the LED element to be focused on the surface of photosensitive drum 24.

Charger roller 26 includes a conductor shaft and a conductive elastic layer. The conductive elastic layer is an elastic layer made of an ionic conductive rubber mainly containing epichlorohydrin (ECO) rubber. The surface of this elastic layer is hardened by a surface treatment where a surface-treatment liquid containing an isocyanate component (HDI) is made to permeate the surface of the elastic layer. Such surface treatment helps to secure a staining property of photosensitive drum 24 and releasability of toner and its external additives. The hardness of the elastic layer is measured with Asker Durometer Type C (manufactured by Kobunshi Keiki Co., Ltd.), and is 73 degrees. The resistance of charger roller 26 is measured in the environment of a temperature of 20° C. and a humidity of 50%. Charger roller 26 is brought into contact with a conductive metal drum that has the same external diameter and the same surface roughness as those of the photosensitive drum used in the first embodiment. The contact force applied in the measurement is the same as the one applied in the image formation. A DC voltage of 500 V is applied to measure the resistance. The resistance of charger roller 26 thus measured shows a value of 6.3 log Q (that is, 1.0E6.3 0).

Cleaner roller 27 includes a metal core with a diameter of 6 mm. A conductive foamed layer made mainly of an ethylene-propylene-diene (EPDM) rubber is bonded to the circumferential surface of the metal core coated with a primer. When observed with a stereomicroscope, the conductive formed layer has an average formed-cell size of 100 μm to 300μm. The hardness of the rubber, measured under the load of 4.9 N with Asker Durometer Type C, ranges from 35 to 45 degrees. The cleaner-roller resistance is measured by pressing cleaner roller 27 into a drum with a diameter of 30 mm by 0.25 mm. A DC voltage of 400 V is applied while cleaner roller 27 is rotating. On the basis of the formula R=V/I, the cleaner-roller resistance thus measured ranges from 2.0E6Ω to 2.0E7Ω.

Although not shown in FIG. 2, each of the rollers and drums has a gear that transmits the drive to the roller or the drum. The gear is fixed to the roller or the drum by press-fitting or by other methods. Specifically, a drum gear is fixed to photosensitive drum 24, a developer gear is fixed to developer roller 21, a sponge gear is fixed to sponge roller 22, a charger gear is fixed to charger roller 26, a cleaner gear is fixed to cleaner roller 27, and a transfer gear is fixed to transfer roller 10. In addition, an idle gear is fixed between the developer gear and the sponge gear.

Next, a description is given of a development process performed by image formation unit 2 that has a configuration described above.

Firstly, when receiving an image-formation instruction from an unillustrated controller, an unillustrated roller-drive-motor controller activates a drive motor to start rotating. When the drive motor starts rotating, the drive force is transmitted to the drum gear via unillustrated gears provided in the main body of printer 1. As a result, photosensitive drum 24 starts rotating.

The rotation of developer roller 21 is started by the transmission of a drive force from the drum gear to the developer gear. Likewise, the rotation of sponge roller 22 is started by the transmission of a drive force from the developer gear to the sponge gear via the idle gear.

In the meanwhile, charger roller 26, cleaner roller 27, and transfer roller 10 start rotating. The rotation of charger roller 26 is started by the transmission of a drive force from the drum gear to the charger gear. The rotation of cleaner roller 27 is started by the transmission of a drive force from the drum gear to the cleaner gear. The rotation of transfer roller 10 is started by the transmission of a drive force from the drum gear to the transfer gear. The rollers and photosensitive drum 24 rotate respectively in the directions indicated by the corresponding arrows in FIG. 2.

With the bias voltage applied to charger roller 26 and the rotation of charger roller 26, the surface of photosensitive drum 24 is electrically charged uniformly (e.g. −600 V). When an electrically charged portion of the surface of photosensitive drum 24 arrives at a position below LED head 25, LED head 25 emits light based on the received image information in accordance with control from the unillustrated head-drive controller, so as to form a latent image on the surface of photosensitive drum 24.

A bias voltage (e.g. −300 V) is applied to sponge roller 22, and a bias voltage (e.g. −200 V) is applied to developer roller 21. When, the portion of the latent image formed on the surface of photosensitive drum 24 arrives at developer roller 21, the potential difference between developer roller 21 and the latent image (e.g. −20V) on the surface of photosensitive drum 24 adheres toner 14, which is made to spread thinly on the surface of development roller 21 by development blade 23, to the portion of the latent image on the surface of photosensitive drum 24. Thus the portion of the latent image is visualized to form a toner image. The development process, which begins with the start of the rotation of photosensitive drum 24, is started at a predetermined timing in the image formation process (which is described below) performed by printer 1.

Next, a description is given of the image formation process of printer 1.

As shown in FIG. 1, paper sheets 3 held in sheet cassette 4 are picked up by Hopping roller 5 one by one from sheet cassette 4 up to a direction indicated by the arrow in FIG. 1. Then, each paper sheet 3 is conveyed, by paired conveyance roller 8 and pinch roller 6 as well as by paired register roller 9 and pinch roller 7, along the sheet conveyance path to image formation unit 2 at a sheet-conveyance speed of 162 mm/sec, for example. While each paper sheet 3 is being conveyed, the orientation of paper sheet 3 is corrected by paired register roller 9 and pinch roller 7. The development process described above is started at a predetermined timing while paper sheet 3 is being conveyed by paired register roller 9 and pinch roller 7.

Then, a transfer process is performed by transfer roller to which a transfer bias voltage is applied by the unillustrated power source for the transfer roller. The toner image formed on the surface of photosensitive drum 24 in the above-described development process is transferred onto paper sheet 3.

Then, paper sheet 3 is conveyed to fixture unit 11 that includes heat roller 12 and backup roller 13. Paper sheet 3 with the transferred toner image is conveyed to a space between heat roller 12 and backup roller 13. The temperature of the surface of heat roller 12 is controlled, by the unillustrated temperature controller, at a predetermined temperature. The heat of heat roller 12 melts toner 14 on paper sheet 3. Melted toner 14 on paper sheet 3 is pressurized in the pressure-contact unit of heat roller 12 and backup roller 13. Thus the toner image is fixed to the surface of paper sheet 3.

Paper sheet 3 with the fixed toner image is conveyed by paired sheet discharge roller 16 and pinch roller 18, and is then discharged to sheet stacker 20 by paired sheet discharge roller 17 and pinch roller 19.

After the transfer of the toner image, a small amount of toner 14 sometimes remains on the surface of photosensitive drum 24. The residue of toner 14 is removed by cleaner roller 27. Cleaner roller 27 is provided to come into contact with a predetermined position on the surface of photosensitive drum 24. Cleaner roller 27 is rotated by the rotation of photosensitive drum 24. Toner 14 that has not been transferred but remains on the surface of photosensitive drum 24 is removed by the rotation of photosensitive drum 24 while photosensitive drum 24 rotates about the rotation axis with cleaner roller 27 being in contact with the surface of photosensitive drum 24. Photosensitive drum 24 that has been cleaned is used again.

Next, a description is given of the toner. The toner used in this embodiment is fabricated in the following way. Particles of a polymerized toner fabricated by the polymerization of a colorant, additives, and a monomer dispersed in an aqueous medium, and specifically, particles of a toner made by emulsion polymerization where styrene acrylic copolymer resin, a colorant, and a wax are mixed and aggregated together, are used as particles of toner base material A. The particles of toner base material A with addition of silica, fine powder of titanium dioxide, and polymethylmethacrylate are mixed together by using a mixer. The product thus fabricated is used as the toner of this embodiment.

Toner particles are fabricated by the emulsion polymerization in the following way. Firstly, primary particles of the polymer, which serves as the binder resin for the toner, are fabricated in an aqueous medium. Then, a colorant emulsified by an emulsifier (surfactant) is mixed in the same solvent in which the primary particles are fabricated, and a wax, a charge-control agent, and the like are also mixed in the solvent if necessary. Then, the components in the solvent are aggregated together to form the toner particles. Then, the toner particles are taken out of the solvent, then rinsed and dried to remove unnecessary components of the solvents and byproduct components. Thus obtained are the toner particles.

In this embodiment, styrene, acrylic acid, and methylmethacrylic acid are used to form the styrene acrylic copolymer resin. Carbon black is used as the colorant. In addition, stearyl stearate, which is a higher fatty acid ester wax, is used as the wax.

By the method described above, particles of toner base material A, i.e. particles of toner with no additives, are obtained. The particles of toner base material A have a volume-average particle size of 7.0 μm. The volume-average particle size of the obtained particles of toner base material A is acquired by measuring, up to 3000 counts, the particles by using a cell counts analyzer, specifically, Coulter Multisizer 3 (manufactured by Beckman Coulter, Inc.) with an aperture diameter of 100 μm. In addition, the degree of circularity of the particles is measured in accordance with the following formula (1) by using a flow-type particle image analyzer, FPIA-2100 (manufactured by Sysmex Corporation).

Degree of circularity=L1/L2 (1)

In the formula (1), L1 is the circumference of a circle that has the same area as the area of the projected image of each particle, and L2 is the perimeter of the projected image of each particle. When the degree of circularity is 1.00, the sample particle has a perfectly spherical shape. As the degree of circularity decreases from 1.00, the sample particle has an indefinite, irregular shape. In this embodiment, an average degree of circularity is calculated with 10 sample particles of toner base material A, and the average degree of circularity of 0.97 is obtained.

### EXAMPLE 1-1

AEROSIL® RX50 (manufactured by Nippon Aerosil Co., Ltd.) of 0.5 parts by weight is added to particles of toner base material A of 100 parts by weight. The mixture is mixed together for 15 minutes, and thus toner A-1 is obtained.

### EXAMPLE 1-2

AEROSIL® RX50 (manufactured by Nippon Aerosil Co., Ltd.) of 0.5 parts by weight is added to particles of toner base material A of 100 parts by weight. The mixture is mixed together for 20 minutes, and thus toner A-2 is obtained.

### EXAMPLE 1-3

AEROSIL® RX50 (manufactured by Nippon Aerosil Co., Ltd.) of 0.5 parts by weight is added to particles of toner base material A of 100 parts by weight. The mixture is mixed together for 25 minutes, and thus toner A-3 is obtained.

### EXAMPLE 1-4

AEROSIL® RX50 (manufactured by Nippon Aerosil Co., Ltd.) of 0.5 parts by weight is added to particles of toner base material A of 100 parts by weight. The mixture is mixed together for 30 minutes, and thus toner A-4 is obtained.

### EXAMPLE 1-5

AEROSIL® RX50 (manufactured by Nippon Aerosil Co., Ltd.) of 0.7 parts by weight is added to particles of toner base material A of 100 parts by weight. The mixture is mixed together for 15 minutes, and thus toner A-5 is obtained.

### EXAMPLE 1-6

AEROSIL® RX50 (manufactured by Nippon Aerosil Co., Ltd.) of 0.7 parts by weight is added to particles of toner base material A of 100 parts by weight. The mixture is mixed together for 20 minutes, and thus toner A-6 is obtained.

### EXAMPLE 1-7

AEROSIL® RX50 (manufactured by Nippon Aerosil Co., Ltd.) of 0.7 parts by weight is added to particles of toner base material A of 100 parts by weight. The mixture is mixed together for 25 minutes, and thus toner A-7 is obtained.

### EXAMPLE 1-8

AEROSIL® RX50 (manufactured by Nippon Aerosil Co., Ltd.) of 0.7 parts by weight is added to particles of toner base material A of 100 parts by weight. The mixture is mixed together for 30 minutes, and thus toner A-8 is obtained.

### EXAMPLE 1-9

AEROSIL® RX50 (manufactured by Nippon Aerosil Co., Ltd.) of 0.7 parts by weight and titanium dioxide (TTO-55, manufactured by Ishihara Sangyo Kaisha Ltd., particle size of 30 nm) of 0.4 parts by weight are added to particles of toner base material A of 100 parts by weight. The mixture is mixed together for 15 minutes, and thus toner A-9 is obtained.

### EXAMPLE 1-10

AEROSIL® RX50 (manufactured by Nippon Aerosil Co., Ltd.) of 0.7 parts by weight and titanium dioxide (TTO-55, manufactured by Ishihara Sangyo Kaisha Ltd., particle size of 30 nm) of 0.4 parts by weight are added to particles of toner base material A of 100 parts by weight. The mixture is mixed together for 20 minutes, and thus toner A-10 is obtained.

### EXAMPLE 1-11

AEROSIL® RX50 (manufactured by Nippon Aerosil Co., Ltd.) of 0.7 parts by weight and titanium dioxide (TTO-55, manufactured by Ishihara Sangyo Kaisha Ltd., particle size of 30 nm) of 0.4 parts by weight are added to particles of toner base material A of 100 parts by weight. The mixture is mixed together for 25 minutes, and thus toner A-11 is obtained.

### EXAMPLE 1-12

AEROSIL® RX50 (manufactured by Nippon Aerosil Co., Ltd.) of 0.7 parts by weight and titanium dioxide (TTO-55, manufactured by Ishihara Sangyo Kaisha Ltd., particle size of 30 nm) of 0.4 parts by weight are added to particles of toner base material A of 100 parts by weight. The mixture is mixed together for 30 minutes, and thus toner A-12 is obtained.

### EXAMPLE 1-13

AEROSIL® RX50 (manufactured by Nippon Aerosil Co., Ltd.) of 0.9 parts by weight is added to particles of toner base material A of 100 parts by weight. The mixture is mixed together for 15 minutes, and thus toner A-13 is obtained.

### EXAMPLE 1-14

AEROSIL® RX50 (manufactured by Nippon Aerosil Co., Ltd.) of 0.9 parts by weight is added to particles of toner base material A of 100 parts by weight. The mixture is mixed together for 20 minutes, and thus toner A-14 is obtained.

### EXAMPLE 1-15

AEROSIL® RX50 (manufactured by Nippon Aerosil Co., Ltd.) of 0.9 parts by weight is added to particles of toner base material A of 100 parts by weight. The mixture is mixed together for 25 minutes, and thus toner A-15 is obtained.

### EXAMPLE 1-16

AEROSIL® RX50 (manufactured by Nippon Aerosil Co., Ltd.) of 0.9 parts by weight is added to particles of toner base material A of 100 parts by weight. The mixture is mixed together for 30 minutes, and thus toner A-16 is obtained.

### EXAMPLE 1-17

AEROSIL® RX50 (manufactured by Nippon Aerosil Co., Ltd.) of 0.9 parts by weight and titanium dioxide (TTO-55, manufactured by Ishihara Sangyo Kaisha Ltd., particle size of 30 nm) of 0.4 parts by weight are added to particles of toner base material A of 100 parts by weight. The mixture is mixed together for 15 minutes, and thus toner A-17 is obtained.

### EXAMPLE 1-18

AEROSIL® RX50 (manufactured by Nippon Aerosil Co., Ltd.) of 0.9 parts by weight and titanium dioxide (TTO-55, manufactured by Ishihara Sangyo Kaisha Ltd., particle size of 30 nm) of 0.4 parts by weight are added to particles of toner base material A of 100 parts by weight. The mixture is mixed together for 20 minutes, and thus toner A-18 is obtained.

### EXAMPLE 1-19

AEROSIL® RX50 (manufactured by Nippon Aerosil Co., Ltd.) of 0.9 parts by weight and titanium dioxide (TTO-55, manufactured by Ishihara Sangyo Kaisha Ltd., particle size of 30 nm) of 0.4 parts by weight are added to particles of toner base material A of 100 parts by weight. The mixture is mixed together for 25 minutes, and thus toner A-19 is obtained.

### EXAMPLE 1-20

AEROSIL® RX50 (manufactured by Nippon Aerosil Co., Ltd.) of 0.9 parts by weight and titanium dioxide (TTO-55, manufactured by Ishihara Sangyo Kaisha Ltd., particle size of 30 nm) of 0.4 parts by weight are added to particles of toner base material A of 100 parts by weight. The mixture is mixed together for 30 minutes, and thus toner A-20 is obtained.

### EXAMPLE 1-21

AEROSIL® RX50 (manufactured by Nippon Aerosil Co., Ltd.) of 1.3 parts by weight is added to particles of toner base material A of 100 parts by weight. The mixture is mixed together for 15 minutes, and thus toner A-21 is obtained.

### EXAMPLE 1-22

AEROSIL® RX50 (manufactured by Nippon Aerosil Co., Ltd.) of 1.3 parts by weight is added to particles of toner base material A of 100 parts by weight. The mixture is mixed together for 20 minutes, and thus toner A-22 is obtained.

### EXAMPLE 1-23

AEROSIL® RX50 (manufactured by Nippon Aerosil Co., Ltd.) of 1.3 parts by weight is added to particles of toner base material A of 100 parts by weight. The mixture is mixed together for 25 minutes, and thus toner A-23 is obtained.

### EXAMPLE 1-24

AEROSIL® RX50 (manufactured by Nippon Aerosil Co., Ltd.) of 1.3 parts by weight is added to particles of toner base material A of 100 parts by weight. The mixture is mixed together for 30 minutes, and thus toner A-24 is obtained.

### EXAMPLE 1-25

AEROSIL® RX50 (manufactured by Nippon Aerosil Co., Ltd.) of 1.3 parts by weight and MP-1000 (polymethylmethacrylate, manufactured by Soken Chemical and Engineering Co., Ltd.) of 0.6 parts by weight are added to particles of toner base material A of 100 parts by weight. The mixture is mixed together for 15 minutes, and thus toner A-25 is obtained.

### EXAMPLE 1-26

AEROSIL® RX50 (manufactured by Nippon Aerosil Co., Ltd.) of 1.3 parts by weight and MP-1000 (polymethylmethacrylate, manufactured by Soken Chemical and Engineering Co., Ltd.) of 0.6 parts by weight are added to particles of toner base material A of 100 parts by weight. The mixture is mixed together for 20 minutes, and thus toner A-26 is obtained.

### EXAMPLE 1-27

AEROSIL® RX50 (manufactured by Nippon Aerosil Co., Ltd.) of 1.3 parts by weight and MP-1000 (polymethylmethacrylate, manufactured by Soken Chemical and Engineering Co., Ltd.) of 0.6 parts by weight are added to particles of toner base material A of 100 parts by weight. The mixture is mixed together for 25 minutes, and thus toner A-27 is obtained.

### EXAMPLE 1-28

AEROSIL® RX50 (manufactured by Nippon Aerosil Co., Ltd.) of 1.3 parts by weight and MP-1000 (polymethylmethacrylate, manufactured by Soken Chemical and Engineering Co., Ltd.) of 0.6 parts by weight are added to particles of toner base material A of 100 parts by weight. The mixture is mixed together for 30 minutes, and thus toner A-28 is obtained.

### EXAMPLE 1-29

AEROSIL® RX50 (manufactured by Nippon Aerosil Co., Ltd.) of 1.5 parts by weight is added to particles of toner base material A of 100 parts by weight. The mixture is mixed together for 15 minutes, and thus toner A-29 is obtained.

### EXAMPLE 1-30

AEROSIL® RX50 (manufactured by Nippon Aerosil Co., Ltd.) of 1.5 parts by weight is added to particles of toner base material A of 100 parts by weight. The mixture is mixed together for 20 minutes, and thus toner A-30 is obtained.

### EXAMPLE 1-31

AEROSIL® RX50 (manufactured by Nippon Aerosil Co., Ltd.) of 1.5 parts by weight is added to particles of toner base material A of 100 parts by weight. The mixture is mixed together for 25 minutes, and thus toner A-31 is obtained.

### EXAMPLE 1-32

AEROSIL® RX50 (manufactured by Nippon Aerosil Co., Ltd.) of 1.5 parts by weight is added to particles of toner base material A of 100 parts by weight. The mixture is mixed together for 30 minutes, and thus toner A-32 is obtained.

Next, the loose bulk densities of toners A-1 to A-32 are measured. The loose bulk density mentioned in the invention represents the packed degree of toner that is loosely filled in a container. If the toner is too densely packed at the time of triboelectric charging during the image formation, the toner is charged so high as to cause “smear.” When, in contrast, the toner is not packed to an appropriate degree, insufficient charging occurs and causes “fogging”. Hence, in this embodiment, the range of the loose bulk density of the toner that indicates a favorable print quality is defined on the basis of the assessment of the “smear,” “fogging,” and “first print time,” which is described later.

The phenomenon “smear” in this embodiment refers to the attachment of toner to a background portion of the image, that is, a non-image portion, while the toner attached as “smear” is excessively charged toner, i.e. toner charged at a higher level than properly charged toner. The excessively charged toner is referred to as the “smear toner.” The phenomenon “fogging” in this embodiment refers to the attachment of toner to a background portion of the image, that is, a non-image portion, while the toner attached as “fogging” is toner charged at a lower level than the toner charged properly, or toner charged to have the opposite polarity to the polarity of properly charged toner. The low-charged toner or the opposite-polarity toner causing the “fogging” phenomenon is referred to as the “fogging toner.”

The loose bulk densities of the toners fabricated in the above-described manners are measured by using Multi Tester (manufactured by Seisin Enterprise Co., Ltd.). Each toner is placed on a sieve with a 250-μm hole size, and then the sieve is oscillated by an amplitude of 1 mm. The toner that passes through the sieve is collected with a 100-ml measuring cylinder. The weight of the empty measuring cylinder is subtracted from the weight of the measuring cylinder filled with 100-ml toner, and thus the weight of the toner of a 100-ml volume is obtained. The loose bulk density of the toner is calculated from the weight of the toner thus obtained.

Then, along with the measurement of the loose bulk density, the release rates of the toners fabricated in the above-described manners are measured. To measure the release rate, a particle analyzer (DP-1000, manufactured by HORIBA Ltd.) is used. The measurement is performed under the following conditions.

Number of carbon atoms (C) detected in each single measurement: 500 to 1500

Noise-cut level: 1.5 V or lower

Sort time: 20 digits

Gas: O₂ 0.1% He gas

Wavelengths analyzed: carbon atom (C) 247.86 nm, silicon atom (Si) 288.16 nm, titanium atom (Ti) 334.90 nm.

The release rate of each atom is calculated by the following formula (2):

Release rate={(the count of atoms that do not emit light simultaneously with the carbon atoms)/[(the count of atoms that illuminate simultaneously with the carbon atoms+the count of atoms that do not illuminate simultaneously with the carbon atoms)]}×100 (2)

Note that the “atoms” mentioned in the formula (2) refer to silicon atoms and/or titanium atoms.

Next, a description is given of the “first print time” according to the embodiment. In this embodiment, the printer is firstly warmed up in a state where no waiting is left for the fixture unit, that is, the printer is powered ON and is left as it is until the temperature of the fixture unit reaches a predetermined temperature, and the “ON-Line” indicator is shown to mean that image formation is now possible. Then, the printer is left as it is for an hour (until the toner is discharged sufficiently). Then, an image-formation command is inputted to print a 5% duty image on a sheet of letter-size standard paper (e.g., Xerox 4200 paper with whiteness of 92, basis weight=20 lb) fed in the portrait orientation (i.e., with the shorter two sides of the four sides being the leading and trailing ends). Note that when a solid-print image occupies 100% of the printable area of a single sheet, the image is 100% duty image. So the “5% duty image” mentioned above refers to an image that occupies 5% of the printable area of the sheet. Once the printing of 5% duty image is finished, the print sheet is discharged completely out to sheet stacker 20. The length of time between the input of the image-formation command and the discharge of the print sheet is defined as the “first print time.”

Table 1 shows the measurement results of toners A-1 to A-32 fabricated in the above-described manners. Note that in Table 1, “Rx50” means AEROSIL® Rx50, “TiO₂” means titanium dioxide, and “PMMA” means polymethylmethacrylate.

TABLE 1

| | | | | External | Loose | Release | First | |
|---|---|---|---|---|---|---|---|---|
| | | | | Addition | Bulk | rate | Print | |
| | | | | Time | Density | (particle | Time | |
| Toner | RX50 | TiO2 | PMMA | (minute) | [g/ml] | analyzer) | (second) | Assessment |
| A-1 | 0.5 | 0.0 | 0.0 | 15 | 0.250 | 5.4 | smear | x |
| A-2 | 0.5 | 0.0 | 0.0 | 20 | 0.259 | 5.0 | smear | x |
| A-3 | 0.5 | 0.0 | 0.0 | 25 | 0.270 | 4.5 | smear | x |
| A-4 | 0.5 | 0.0 | 0.0 | 30 | 0.278 | 4.1 | smear | x |
| A-5 | 0.7 | 0.0 | 0.0 | 15 | 0.291 | 6.2 | smear | x |
| A-6 | 0.7 | 0.0 | 0.0 | 20 | 0.300 | 5.0 | 4.8 | ∘ |
| A-7 | 0.7 | 0.0 | 0.0 | 25 | 0.307 | 4.8 | smear | x |
| A-8 | 0.7 | 0.0 | 0.0 | 30 | 0.314 | 4.2 | smear | x |
| A-9 | 0.7 | 0.4 | 0.0 | 15 | 0.310 | 18.9 | 6.1 | x |
| A-10 | 0.7 | 0.4 | 0.0 | 20 | 0.307 | 17.3 | 6.3 | x |
| A-11 | 0.7 | 0.4 | 0.0 | 25 | 0.300 | 15.0 | 4.9 | ∘ |
| A-12 | 0.7 | 0.4 | 0.0 | 30 | 0.280 | 14.1 | 5.9 | x |
| A-13 | 0.9 | 0.0 | 0.0 | 15 | 0.320 | 7.0 | 3.8 | ∘ |
| A-14 | 0.9 | 0.0 | 0.0 | 20 | 0.335 | 7.2 | 3.8 | ∘ |
| A-15 | 0.9 | 0.0 | 0.0 | 25 | 0.348 | 7.7 | 3.6 | ∘ |
| A-16 | 0.9 | 0.0 | 0.0 | 30 | 0.350 | 8.5 | 3.6 | ∘ |
| A-17 | 0.9 | 0.4 | 0.0 | 15 | 0.320 | 14.0 | 3.7 | ∘ |
| A-18 | 0.9 | 0.4 | 0.0 | 20 | 0.373 | 13.7 | 3.7 | ∘ |
| A-19 | 0.9 | 0.4 | 0.0 | 25 | 0.381 | 12.8 | 3.8 | ∘ |
| A-20 | 0.9 | 0.4 | 0.0 | 30 | 0.390 | 11.9 | 3.8 | ∘ |
| A-21 | 1.3 | 0.0 | 0.0 | 15 | 0.406 | 10.1 | 4.8 | ∘ |
| A-22 | 1.3 | 0.0 | 0.0 | 20 | 0.405 | 9.2 | 4.9 | ∘ |
| A-23 | 1.3 | 0.0 | 0.0 | 25 | 0.400 | 7.0 | 3.8 | ∘ |
| A-24 | 1.3 | 0.0 | 0.0 | 30 | 0.420 | 5.0 | 4.8 | ∘ |
| A-25 | 1.3 | 0.0 | 0.6 | 15 | 0.411 | 16.9 | 6.3 | x |
| A-26 | 1.3 | 0.0 | 0.6 | 20 | 0.420 | 15.0 | 4.8 | ∘ |
| A-27 | 1.3 | 0.0 | 0.6 | 25 | 0.431 | 13.7 | 5.4 | x |
| A-28 | 1.3 | 0.0 | 0.6 | 30 | 0.440 | 12.4 | 5.8 | x |
| A-29 | 1.5 | 0.0 | 0.0 | 15 | 0.400 | 14.0 | 3.9 | ∘ |
| A-30 | 1.5 | 0.0 | 0.0 | 20 | 0.414 | 10.6 | 4.9 | ∘ |
| A-31 | 1.5 | 0.0 | 0.0 | 25 | 0.425 | 9.1 | 6.8 | x |
| A-32 | 1.5 | 0.0 | 0.0 | 30 | 0.426 | 8.4 | 7.0 | x |

As shown clearly in Table 1, some of the toners located in the regions with loose bulk densities that are not larger than 0.299 g/ml and some of the toners located in the regions with release rates that are lower than 5% cause “smear,” that is, a phenomenon of the attachment of toner to a non-image portion within the 5% duty image. An “×” mark is put as the assessment for each of such toners in Table 1. A possible reason for the “smear” is the rise of chargeability of such toners up to unnecessarily high levels, which is caused by the external additives strongly adsorbed to the particles of toner base material.

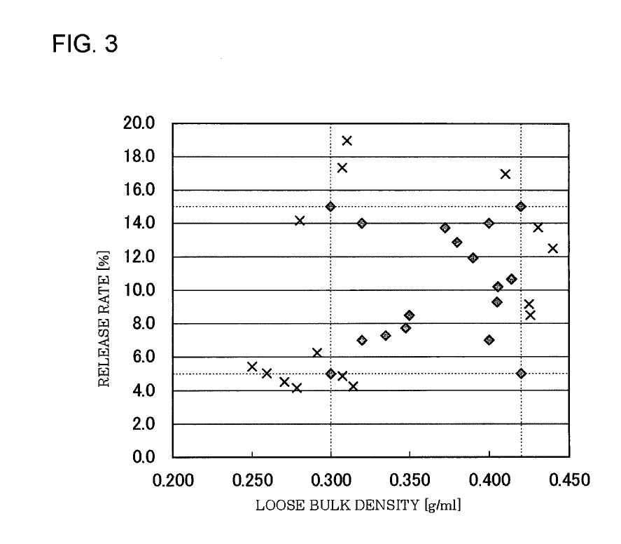

On the other hand, the toners located in the regions with the loose bulk densities that are not smaller than 0.421 g/ml and the toners located in the regions with release rates that are not lower than 15.1% have a first print time of 5 seconds or more. The first print time is one of the important specs of printers, and a shorter first print time is preferred. Hence, an “×” mark is given to the assessment of a toner with a first print time of 5 seconds or more. FIG. 3 shows the results of the assessments of the toners. Like the toners fabricated by conventional manufacturing methods, the toners with the above-mentioned conditions contain external additives that are probably adsorbed weakly to the particles of toner base material. Accordingly, it takes a longer time for such toners to be triboelectrically charged in image formation unit 2 up to a charged level that enables printing.

It is found from these results that no “smear” is caused in the toners with a loose bulk density of 0.300 g/ml to 0.420 g/ml and a release rate of 5% to 15%. At the same time, all the toners with the above-mentioned loose bulk density and release rate only need a first print time of less than 5 seconds.

As has been described above, according to the first embodiment, both a favorable image quality and sufficiently short first print time can be secured by using any of the toners with loose bulk densities of 0.300 g/ml to 0.420 g/ml and with release rates of 5% to 15%.

### Second Embodiment

In a second embodiment, a drum-fogging assessment is performed on the toners assessed in the first embodiment as the toners with favorable image quality and sufficiently short first print time, i.e. toners A-6, A-11, A-13, A-14, A-15, A-16, A-17, A-18, A-19, A-20, A-21, A-22, A-23, A-24, A-26, A-29, and A-30. With the drum-fogging assessment, a more preferable range of the loose bulk density and a more preferable range of the release rate are defined in the second embodiment.

The printer and the image formation unit used in the second embodiment have configurations that are identical to those in the first embodiment. In addition, the development process, the image formation process, and the fabrication of the toners are performed in similar manners to those in the first embodiment. Hence, no description of these items is given below.

To perform the drum-fogging assessment, a 5% duty image is printed on 500 sheets of letter-size standard paper (e.g., Xerox 4200 paper with whiteness of 92, basis weight=20 lb) fed in the portrait orientation (i.e., with the shorter two sides of the four sides being the leading and trailing ends). Note that when a solid-print image occupies 100% of the printable area of a single sheet, the image is 100% duty image. So the “5% duty image” mentioned above refers to an image that occupies 5% of the printable area of the sheet. A sheet with no images (blank sheet) is printed for every 100 prints of the 5% duty image, and the printing is stopped temporarily to pick up the sample of drum fogging.

To assess the drum fogging, a transparent mending tape is firstly attached to photosensitive drum 24 taken out of printer 1, and then the tape is removed for the purpose of removing the toner adhering to photosensitive drum 24. The removed mending tape is then attached to a sheet of white paper. Another piece of unused mending tape is attached beforehand to the sheet of white paper. Thereafter, Minolta Spectrophotometer CM-2600d (manufactured by Konica Minolta Sensing Inc.) with a measurement diameter of 8 mm is used to measure the average value of color difference ΔE between the unused mending tape on the sheet of white paper and the mending tape removed from photosensitive drum 24. Note that the color difference ΔE={(L₁−L₂)²+(a₁−a₂)²+(b₁−b₂)²}^{1/2}, where L₁, a₁, and b₁ are the chromaticity of the mending tape removed from photosensitive drum 24 at the time of temporary stop of printing for the blank sheet; and L₂, a₂, and b₂ are the chromaticity of the unused mending tape. To calculate the average value, 5 points of similar positions are measured.

The assessment of the drum fogging is based on the following criteria:

∘: color difference ΔE is 1.5 or less

×: color difference ΔE is 1.6 or more

Table 2 shows the measurement results of toners A-6, A-11, A-13, A-14, A-15, A-16, A-17, A-18, A-19, A-20, A-21, A-22, A-23, A-24, A-26, A-29, and A-30.

TABLE 2

| | | | | External | Loose | Release | First | |
|---|---|---|---|---|---|---|---|---|
| | | | | Addition | Bulk | rate | Print | |
| | | | | Time | Density | (particle | Time | |
| Toner | RX50 | TiO2 | PMMA | (minute) | [g/ml] | analyzer) | (second) | Assessment |
| A-6 | 0.7 | 0.0 | 0.0 | 20 | 0.300 | 5.0 | 4.8 | smear |
| A-11 | 0.7 | 0.4 | 0.0 | 25 | 0.300 | 15.0 | 4.9 | fogging |
| A-13 | 0.9 | 0.0 | 0.0 | 15 | 0.320 | 7.0 | 3.8 | ∘ |
| A-14 | 0.9 | 0.0 | 0.0 | 20 | 0.335 | 7.2 | 3.8 | ∘ |
| A-15 | 0.9 | 0.0 | 0.0 | 25 | 0.348 | 7.7 | 3.6 | ∘ |
| A-16 | 0.9 | 0.0 | 0.0 | 30 | 0.350 | 8.5 | 3.6 | ∘ |
| A-17 | 0.9 | 0.4 | 0.0 | 15 | 0.320 | 14.0 | 3.7 | ∘ |
| A-18 | 0.9 | 0.4 | 0.0 | 20 | 0.373 | 13.7 | 3.7 | ∘ |
| A-19 | 0.9 | 0.4 | 0.0 | 25 | 0.381 | 12.8 | 3.8 | ∘ |
| A-20 | 0.9 | 0.4 | 0.0 | 30 | 0.390 | 11.9 | 3.8 | ∘ |
| A-21 | 1.3 | 0.0 | 0.0 | 15 | 0.406 | 10.1 | 4.8 | fogging |
| A-22 | 1.3 | 0.0 | 0.0 | 20 | 0.405 | 9.2 | 4.9 | fogging |
| A-23 | 1.3 | 0.0 | 0.0 | 25 | 0.400 | 7.0 | 3.8 | ∘ |
| A-24 | 1.3 | 0.0 | 0.0 | 30 | 0.420 | 5.0 | 4.8 | smear |
| A-26 | 1.3 | 0.0 | 0.6 | 20 | 0.420 | 15.0 | 4.8 | fogging |
| A-29 | 1.5 | 0.0 | 0.0 | 15 | 0.400 | 14.0 | 3.9 | ∘ |
| A-30 | 1.5 | 0.0 | 0.0 | 20 | 0.414 | 10.6 | 4.9 | fogging |

In this embodiment, when the adhesion of toner to the non-image portion of the 5% duty image occurs within the 500 prints, the toner is assessed as “smear.” When the drum fogging (i.e. the color difference ΔE) exceeds 1.6 within the 500 prints, the non-image portion appears grayish. Accordingly, the toner with the drum fogging (i.e. the color difference ΔE) that exceeds 1.6 is assessed as “fogging.”

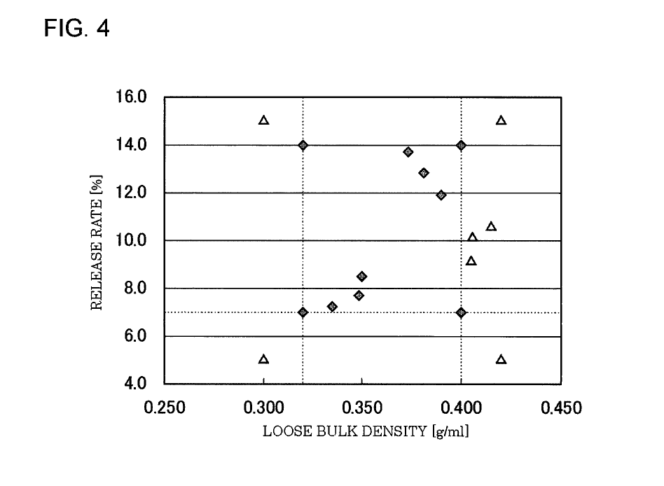

FIG. 4 is a graph showing the assessment results. As shown in Table 2 and FIG. 4, some of the toners located in the regions with release rates of 7% or less causes “smear” within the 500 prints. In addition, some of the toners located in the regions with release rates of 14.1% or more causes “fogging.” The toners located in the regions with loose bulk densities of less than 0.320 g/ml and the toners located in the regions with loose bulk densities of 0.401 g/ml or more causes either “smear” or “fogging.”

A possible reason for the occurrence of “smear” is the unnecessarily high chargeability of the toner caused by the external additives strongly adsorbed to the particles of toner base material. A possible reason for the “fogging” is the insufficient charges caused by the removal of the external additives weakly adsorbed to the particles of toner base material.

It is found from these assessment results that any toner located in the regions with the loose bulk density of 0.320 g/ml to 0.400 g/ml and with the release rate of 7% to 14% causes neither “smear” nor “fogging” and renders the first print time shorter than 5 seconds.

As described thus far, according to the second embodiment, both a favorable image quality and sufficiently short first print time can be secured by using any of the toners with the loose bulk densities of 0.320 g/ml to 0.400 g/ml and release rates of 7% to 14%.

Note that the particles of toner base material described in the embodiments have a volume-average particle size of 7.0 μm and an average degree of circularity of 0.97. However, the invention is not limited to this embodiment. Similar effects can be obtained as long as the particles of toner base material have a volume-average particle size of 6.8 μm to 7.3 μm and an average degree of circularity of 0.95 to 0.98.

A volume-average particle size of smaller than 6.8 μm reduces the transferability of the toner image onto the sheet of paper. A volume-average particle size of larger than 7.3 μm reduces the reproducibility of the dots of the toner image with respect to the dots of the latent-image portion. An average degree of circularity of lower than 0.95 reduces the transferability of the toner image onto the sheet of paper. Note that an average degree of circularity of 1.00 (i.e. a perfectly spherical shape) is ideal. It is, however, substantially impossible to fabricate perfectly spherical particles of toner base material. The toner with an average degree of circularity of 0.98 or less produces similar effects. The toner with an average degree of circularity of more than 0.98 presumably produces a better result.

In the description of the embodiments of the invention, a printer is used as an example of the image formation apparatus. However, the invention can also be applied to an MFP (multi function peripheral), a fax machine, a photocopier, and the like.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. A developer comprising:
particles of developer base material containing a binder resin; and
external additive added to surfaces of the particles of developer base material,
wherein a loose bulk density is not smaller than 0.300 g/ml and not larger than 0.420 g/ml, and a release rate of the external additive from the particles of developer base material is not lower than 5% and not higher than 15%.

2. The developer according to claim 1 wherein the loose bulk density is not smaller than 0.320 g/ml and not larger than 0.400 g/ml, and the release rate of the external additive from the particles of developer base material is not lower than 7% and not higher than 14%.

3. The developer according to claim 1 wherein the particles of developer base material contain a colorant.

4. The developer according to claim 1 wherein the particles of developer base material have an average circularity of 0.95 to 0.98.

5. The developer according to claim 1 wherein the particles of developer base material have a volume-average particle size of 6.8 μm to 7.3 μm.

6. The developer according to claim 1 wherein the particles of developer base material comprises an aggregation of particles of the binder resin.

7. An image formation unit comprising:
a developer of claim 1; and
a developer carrier configured to carry the developer.

8. The image formation unit according to claim 7 wherein the developer carrier includes a shaft and an elastic layer formed on a circumference of the shaft.

9. The image formation unit according to claim 7 further comprising a developer-layer formation member configured to come into contact with the developer carrier and to form a developer layer on the developer carrier.

10. The image formation unit according to claim 7 further comprising a developer supplier configured to supply the developer to the developer carrier.

11. The image formation unit according to claim 7 further comprising an image carrier configured to have a latent image formed on a surface of the image carrier,
wherein the developer carrier is configured to supply the developer to the latent image formed on the image carrier.

12. An image formation apparatus comprising an image formation unit of claim 7.

13. An image formation apparatus comprising:
an image formation unit including a developer of claim 1, an image carrier configured to have a latent image formed on a surface of the image carrier, and a developer carrier configured to form a developer image on the image carrier by supplying the developer to the latent image formed on the image carrier;
a transfer unit configured to transfer the developer image on the image carrier onto a print medium; and
a fixture unit configured to fix the developer transferred onto the print medium.
